(19) United States
(12) Patent Application Publication
(10) Pub. No.: US 2006/0264576 A1
(43) Pub. Date: Nov. 23, 2006

(54) Process to prepare stable trifluorostyrene containing compounds grafted to base polymers

(76) Inventors: Mark Gerrit Roelofs, Hockessin, DE (US); Zhen-Yu Yang, Hockessin, DE (US); Amy Qi Han, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/388,826

(22) Filed: Mar. 24, 2006

Related U.S. Application Data
(60) Provisional application No. 60/664,761, filed on Mar. 24, 2005.

(51) Int. Cl. C08F 297/02

(52) U.S. Cl. 525/242

(57) ABSTRACT

A fluorinated ion exchange polymer is prepared by grafting at least one grafting monomer derived from trifluorostyrene on to at least one base polymer in the presence of a fluorosurfactant. These ion exchange polymers are useful in preparing catalyst coated membranes and membrane electrode assemblies used in fuel cells.

### FIELD OF THE INVENTION

The present invention relates to a process to graft a compound to a base polymer, and its use in electrochemical cells as membranes, and more particularly to the use of these grafted polymers in fuel cells. This invention was made with government support under Contract No. DE-FC04-02AL67606 awarded by the U.S. Department of Energy. The government has certain rights in the invention.

### BACKGROUND OF THE INVENTION

Electrochemical cells, such as fuel cells and lithium-ion batteries are known. Depending on the operating conditions, each type of cell places a particular set of requirements upon the electrolytes used in them. For fuel cells, this is typically dictated by the type of fuel, such as hydrogen or methanol, used to power the cell and the composition of the membrane used to separate the electrodes. Proton-exchange membrane fuel cells, powered by hydrogen as the fuel, could be run at higher operating temperatures than currently employed to take advantage of lower purity feed streams, improved electrode kinetics, better heat transfer from the fuel cell stack to improve its cooling. Waste heat is also employed in a useful fashion. However, if current fuel cells are to be operated at greater than 100° C. then they must be pressurized to maintain adequate hydration of typical proton-exchange membranes to support useful levels of proton conductivity.

There is an ongoing need to discover novel grafted films that improve the performance of the latest generation of electrochemical cells, such as fuel cells and lithium-ion batteries, to develop new membrane materials that will maintain adequate proton conductivity at lower levels of hydration and have sufficient durability for the intended application.

### SUMMARY OF THE INVENTION

In a first aspect, the invention is directed to a grafting process for making a fluorinated ion exchange polymer membrane comprising:
(a) forming an monomer composition comprising at least one grafting monomer, in emulsion form, wherein the grafting monomer comprises one or more of 1a, 1b, 2, or 2b: 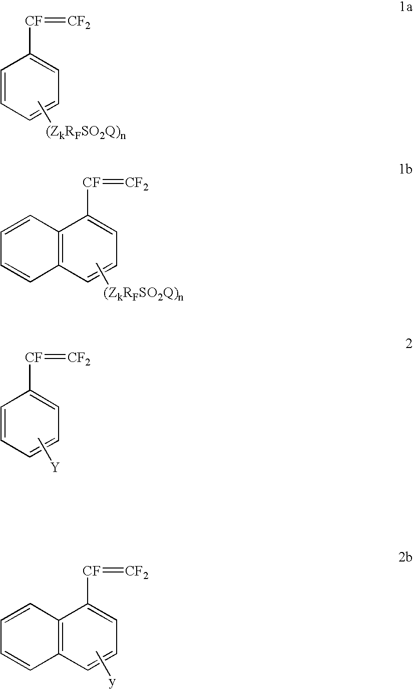
   wherein Zₖ comprises S, SO₂, or POR wherein R comprises a linear or branched perfluorbalkyl group of 1 to 14 carbon atoms optionally containing oxygen or chlorine, an alkyl group of 1 to 8 carbon atoms, an aryl group of 6 to 12 carbon atoms or a substituted aryl group of 6 to 12 carbon atoms;

R_{F} comprises a linear or branched perfluoroalkylene group of 1 to 20 carbon atoms, optionally containing oxygen or chlorine; Q is chosen from F, —OM, —NH₂, —N(M)SO₂R²_{F}, and —C(M)(SO₂)₂, wherein M comprises H, an alkali cation, or ammonium;

R²_{F} comprises an alkyl group of 1 to 14 carbon atoms which may optionally include ether oxygens or aryl of 6 to 12 carbon atoms where the alkyl or aryl groups may be perfluorinated or partially fluorinated,

Y comprises H; halogen such as Cl, Br, F or I; linear or branched alkyl or perfluoroalkyl groups, wherein the alkyl group comprises C1 to C10 carbon atoms; or a perfluoroalkyl group containing oxygen, chlorine or bromine, and wherein the alkyl group comprises C1 to C10 carbon atoms, —CF═CF₂, —(R_{F}SO₂F)n, —(SO₂Q)ₙ, —(PO₃M₂)ₙ, —(CO₂M)ₙ;

n is 1 or 2 for formulae 1 and 2 , and n is 1, 2, or 3 for formulae 1b and 2b; and

k is 0 or 1; in the presence of a fluorinated surfactant.
(b) irradiating at least one base polymer with ionizing radiation, and
(c) contacting at least one base polymer with the monomer composition from step (a), at a temperature of about 0° C. to about 120° C. for about 0.1 hours to about 500 hours. The surfactant can optionally include an enhancing additive.

A second aspect of the invention is a polymer made by the process described above.

A third aspect of the invention is a catalyst coated membrane comprising a polymer electrolyte membrane having a first surface and a second surface, wherein the polymer electrolyte membrane comprises the polymer described above.

A fourth aspect of the invention is a membrane electrode assembly comprising a polymer electrolyte membrane, having a first surface and a second surface, wherein the polymer electrolyte membrane comprises the polymer described above.

A fifth aspect of the invention is an electrochemical cell comprising a membrane electrode assembly, wherein the membrane electrode assembly comprises a polymer electrolyte membrane, having a first surface and a second surface, wherein the polymer electrolyte membrane comprises the polymer described above. The electrochemical cell can be a fuel cell.

### BRIEF DESCRIPTION OF DRAWINGS

FIG. 1 is a schematic illustration of a single cell assembly.

FIG. 2 is a schematic illustration of the lower fixture of a four-electrode cell for in-plane conductivity measurement.

### DETAILED DESCRIPTION OF THE INVENTION

Fluorinated Ion Exchange Polymer:

The fluorinated ion exchange polymers of the invention are useful as polymer electrolyte membranes in fuel cells, chloralkali cells, batteries, electrolysis cells, ion exchange membranes, sensors, electrochemical capacitors, and modified electrodes.

Processes for Making Grafted Polymers and Membranes:

The invention is directed to a grafting process for making a fluorinated ion exchange polymer membrane comprising the steps of:

(a) forming an monomer composition comprising at least one grafting monomer, in emulsion form, wherein the grafting monomer comprises one or more of 1a, 1b, 2, or 2b: 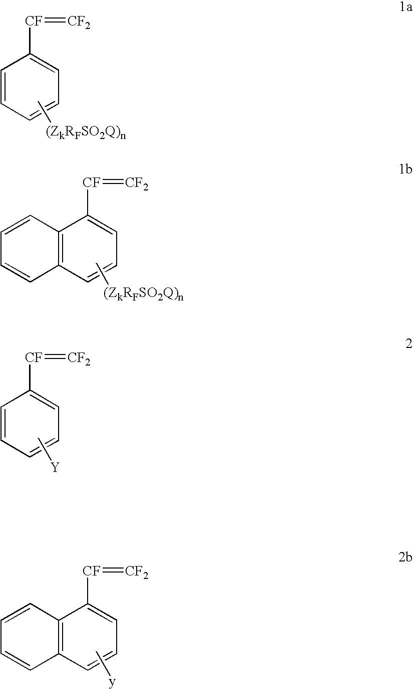
wherein Zₖ comprises S, SO₂, or POR wherein R comprises a linear or branched perfluoroalkyl group of 1 to 14 carbon atoms optionally containing oxygen or chlorine, an alkyl group of 1 to 8 carbon atoms, an aryl group of 6 to 12 carbon atoms or a substituted aryl group of 6 to 12 carbon atoms;

R_{F} comprises a linear or branched perfluoroalkylene group of 1 to 20 carbon atoms, optionally containing oxygen or chlorine; Q is chosen from F, —OM, —NH₂, —N(M)SO₂R²_{F}, and —C(M)(SO₂R²_{F})₂, wherein M comprises H, an alkali cation, or ammonium;

R²_{F} comprises an alkyl group of 1 to 14 carbon atoms which may optionally include ether oxygens or aryl of 6 to 12 carbon atoms where the alkyl or aryl groups may be perfluorinated or partially fluorinated,

Y comprises H; halogen such as Cl, Br, F or I; linear or branched alkyl or perfluoroalkyl groups, wherein the alkyl group comprises C1 to C10 carbon atoms; or a perfluoroalkyl group containing oxygen, chlorine or bromine, and wherein the alkyl group comprises C1 to C10 carbon atoms, —CF═CF₂, —(R_{F}SO₂F)n, —(SO₂Q)ₙ, —(PO₃M₂)ₙ, —(CO₂M)ₙ;

n is 1 or 2 for formulae 1 and 2 , and n is 1, 2, or 3 for formulae 1b and 2b; and

k is 0 or 1; in the presence of a fluorinated surfactant;
(b) irradiating at least one base polymer with ionizing radiation, and
(c) contacting at least one base polymer with the monomer composition from step (a), at a temperature of about 0° C. to about 120° C. for about 0.1 hours to about 500 hours.

The attached pendant group(s) in Formulae 1, 2, 1b and 2b can be attached to any open valence in the ring. In Formulae 1b and 2b the pendant group can be attached to either ring in the structure, and if more than one pendant group is present, can be attached to one or both rings.

By fluorinated surfactant it is meant a surfactant with at least one fluorinated alkyl substituent. The surfactant can be anionic, cationic, or nonionic. Examples of suitable surfactants include C8 (ammonium perfluorooctanoate), Zonyl® fluorosurfactants such as Zonyl® 62, Zonyle TBS, Zonyl® FSP, Zonyl® FS-62, Zonyl® FSA, Zonyl® FSH, and fluorinated alkyl ammonium salts such as but not limited to R′_{w}NH(_{4-w})X wherein X is Cl⁻, Br⁻, I⁻, F⁻, HSO₄⁻, or H₂PO₄⁻, where R′ is (R_{F}CH₂CH₂)—. Zonyl® fluorosurfactants are available from E. I. DuPont de Nemours, Wilmington, Del. and in general are anionic, cationic, amphoteric or nonionic oligomeric hydrocarbons containing ether linkages and fluorinated substituents. For example, Zonyl® FSP is an anionic surfactant of the formula (R_{f}CH₂CH₂)ₓPO(O—NH₄⁺)_{y}, where x+y=3 and Zonyl® FSH is a nonionic surfactant of the formula R_{f}CH₂CH₂O(CH₂CH₂O)_{w}H.

One or more surfactants may be used. The surfactant is typically present at an amount of 0.001 to 15 weight percent of the emulsion, more typically at an amount of 0.01 to 5 weight percent of the emulsion.

Enhancing additives can optionally be used to enhance the grafting rate or to enhance film quality. Suitable additives are water insoluble organic compounds that are solvents for the monomer or monomers used. One or more enhancing additives may be used. Suitable enhancing additives can include α,α,α-trifluorotoluene, dichlorobenzotrifluoride, chlorobenzotrifluoride, chlorobenzene, dichlorobenzene, trichlorobenzene, fluorobenzene, difluorobenzene, trifluorobenzene, perfluorobenzene, toluene, p-xylene, m-xylene, o-xylene, or C5-C10 aliphatic hydrocarbon, fluorohydrocarbon, fluorocarbon, and fluoroether. The enhancing additive is typically present at an amount of 0.5 to 300-weight % of the monomer.

In different embodiments of the invention, Y is —(R_{F}SO₂F)ₙ, Q is F. R_{F} is chosen from (CF₂)_{q} wherein q=1 to 16, (CF₂)_{q}OCF₂CF₂ wherein q=1 to 12, and (CF₂CF(CF3)O)_{q} CF₂CF₂ where q is 1 to 6, and R²_{F} is chosen from methyl, ethyl, propyl, butyl, and phenyl, each of which may be partially fluorinated or perfluorinated, or R_{F} is chosen from (CF₂)_{q} wherein q=1 to 4, (CF₂)_{q}OCF₂CF₂ wherein q=1 to 4, and (CF₂CF(CF₃)O)_{q}CF₂CF₂ where q is 1 to 2, and R²_{F} is chosen from perfluoromethyl, perfluoroethyl, and perfluorophenyl.

In the above process steps (b) and (c) can be performed simultaneously or sequentially.

The monomers can be obtained commercially or prepared using any process known in the art. Methods to prepare these monomers are detailed in WO2005/113621, WO2005/049204, WO2005/113491, and WO2005/003083, all herein incorporated entirely by reference.

Base Polymer:

The base polymer to be used as the substrate for the grafting reaction may be a homopolymer or copolymer of non-fluorinated, fluorinated, and perfluorinated monomers. Partially or completely fluorinated polymers often impart increased chemical stability and are more typical. The base polymer is typically chosen so that it imparts desirable mechanical properties to the final grafted polymer, is stable to the irradiation used to activate the polymer for grafting, and is stable under the conditions to which it is exposed during use. For separators or membranes it is desirable that the base polymer be present in the form of a film, though other shapes may be desired depending on the electrochemical use. Some typical base polymers may include poly(ethylene-tetrafluorethylene-termonomer (ETFE) that comprises a terpolymer of ethylene and tetrafluoroethylene (TFE), in the range of 35:65 to 65:35 (mole ratios) with from 1 to 10 mole % of a termonomer, perfluorobutyl ethylene in the case of DuPont Tefzel®); ETFE copolymers also using other termonomers (Neoflon® ETFE); ECTFE that comprises a copolymer of ethylene and chlorotrifluoroethylene; FEP that comprises a copolymer of TFE and hexafluoropropylene (HFP), optionally containing a minor amount (1-3 mol %) of perfluoro(alkyl vinyl ether) (PAVE), usually perfluoro(propyl vinyl ether) (PPVE) or perfluoro(ethyl vinyl ether) (PEVE); PFA that comprises a copolymer of TFE and PAVE, wherein PAVE may be PPVE or PEVE; MFA that comprises a copolymer of TFE, PMVE, and PPVE; PTFE that comprises a homopolymer of TFE; modified PTFE, that contains up to 0.5 mol % of another monomer, usually a PAVE; PVF that comprises a polymer of vinyl fluoride (VF); PVDF that comprises a polymer of vinylidene fluoride (VF2); copolymers of VF2 and HFP which are sold under the trademarks KynarFlex®) and Viton® A by Atofina and by DuPont, respectively; polyethylene and polypropylene. The term “modified” distinguishes these polymers from copolymers of TFE. The modified PTFE polymers are, like PTFE, not melt processible.

Typically, the base polymer may be chosen from poly(ethylene-tetrafluoroethylene), poly(ethylene-tetrafluoroethylene-termonomer) (Tefzel®D, Neoflon®) ETFE); poly(tetrafluoroethylene-hexafluoropropylene) (Teflon® FEP); poly(tetrafluoroethylene-perfluorovinylether) (Teflon® PFA), polytetrafluoroethylene (Teflon® PTFE); poly(ethylene-chlorotrifluoroethylene); poly(vinyledene fluoride) (Kynar® or Solef®); and

poly(vinylidenefluoride-hexafluoropropylene) (Kynar® Flex). More typically, the base polymer is chosen from poly(ethylene-tetrafluoroethylene-termonomer), poly(tetrafluoroethylene-hexafluoropropylene), poly(tetrafluoroethylene-perfluoropropylvinylether), and poly(vinyledene fluoride).

Free radicals may be created in the base polymer in order to produce attachment sites for the grafting monomers using radiation.

When the base polymer is in film form, the films are known as irradiated films. The radiation dosage should be sufficient to allow for the desired graft level to be reached, but not so high as to cause excessive radiation damage. Graft level is defined as (wt. of grafted polymer—wt. of base polymer)/(wt. of base polymer). (This is also known as weight uptake). The ionizing radiation may be provided in the form of electron beam, gamma ray, or X-rays. Electron beam irradiation is typically performed at a high dose rate that may be advantageous for commercial production. The irradiation may be done while the base polymer is in contact with the grafting monomers (simultaneous irradiation and, grafting). However, if the e free radicals of the base polymer are sufficiently stable, then the irradiation may be performed first and in a subsequent step the base polymer may. be brought into contact with the grafting monomers (post-irradiation grafting). Base polymers suitable for the post-irradiation grafting method are usually fluorinated polymers. In this case the irradiation may typically be done at sub-ambient temperatures, for example with base polymer cooled with dry ice, and it may be stored at a sufficiently low temperature to prevent decay of the free radicals prior to its use in the grafting reaction.

With some substrates, such as poly(ethylene-tetrafluoroethylene) the irradiation may be performed in the presence of oxygen or in an oxygen-free environment, and an appreciable graft level can be obtained in either case. Typically grafting may be performed in an inert gas, such as nitrogen or argon. This may be accomplished by loading the base polymer films, within an inert-atmosphere box, into oxygen-barrier bags, sealing them shut (with or without grafting monomers and solvent), and then irradiating. In the case of post-irradiation grafting, the base polymer may then also be stored in the oxygen-free environment before and during the grafting reaction.

The grafting reaction may be performed by exposing the base polymer to a monomer composition containing the grafting monomers. It is generally desirable to lower the quantity of fluorinated monomer used in the grafting reaction, and this may be accomplished by diluting it by forming an aqueous emulsion, which thus increases the total working volume of the monomer composition. The monomer composition may thus be an emulsion made by mechanical or ultrasonic mixing of the monomers with water. The monomer may also be additionally present in a separate phase and not part of the emulsion.

Grafting may be accomplished by contacting the base polymer films, during irradiation or subsequent to irradiation, with the monomer composition and holding films at about 0° C. to about 120° C. for about 0.1 to about 500 hours. Typical temperatures are about 25° C. to about 100° C., more typically about 35 to about 90° C., and most typically about 40 to about 80° C. Typical times are about 10 min to about 300 hours, more typically about 1 hour to about 200 hours, and most typically about 1 hour to about 100 hours. Subsequent to the grafting reaction, the emulsion, additive if present and unreacted monomer may be removed by extraction with a low-boiling solvent or through vaporization. The grafted polymer may also be extracted with a solvent in order to remove any polymer formed in the film that is not grafted to the base film.

Preparation of Ionic Polymers:

This invention provides for the facile conversion of the fluorosulfonyl fluorides to acid form, without the use of sulfonation reagents. Polymers grafted with the monomers bearing pendant sulfonyl fluoride groups may be hydrolyzed with bases such as MOH or M₂CO₃ (M=Li, Na, K, Cs, NH₄) or MOH in MeOH and/or DMSO, and water. The hydrolysis may usually be carried out at room temperature to about 100° C., typically at room temperature to about 80° C. With polymeric substrates such as PVDF that are sensitive to strong base, it is preferable to use the weaker carbonate bases that avoid decomposition of the substrate. Treatment of polymeric salts with acids such as HNO₃ gives polymeric acids.

The grafted sulfide polymers (Z=S) may be oxidized to sulfone polymers (Z=SO₂) using CrO₃ or hydrogen peroxide.

Electrochemical Cell:

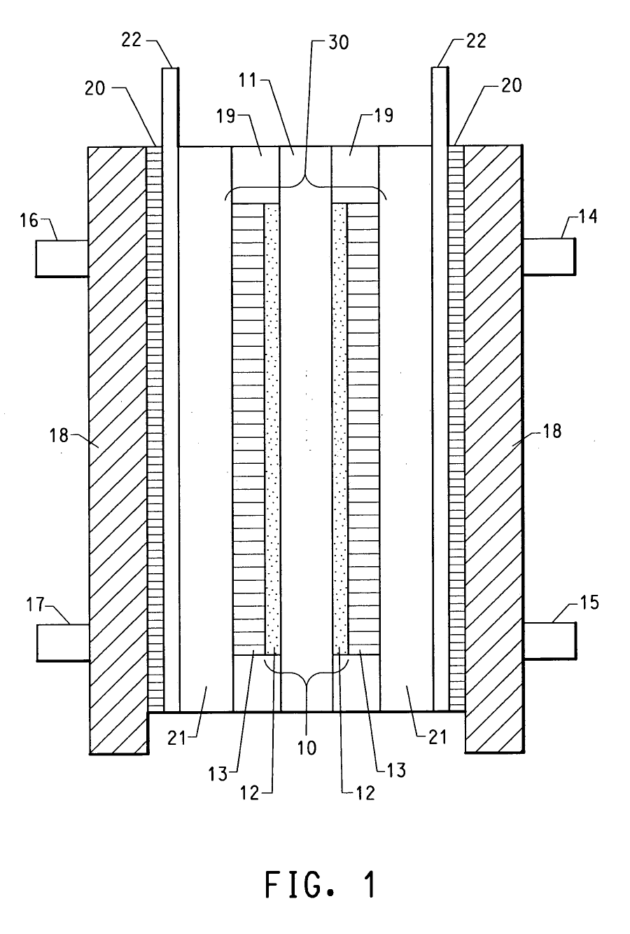

As shown in FIG. 1, an electrochemical cell, such as a fuel cell, comprises a catalyst-coated membrane (CCM) (10) in combination with at least one gas diffusion backing (GDB) (13) to form an unconsolidated membrane electrode assembly (MEA). The catalyst-coated membrane (10) comprises a polymer electrolyte membrane (11) discussed above and catalyst layers or electrodes (12) formed from an electrocatalyst coating composition. The fuel cell may be further provided with an inlet (14) for fuel, such as hydrogen; liquid or gaseous alcohols, e.g. methanol and ethanol; or ethers, e.g. diethyl ether, etc., an anode outlet (15), a cathode gas inlet (16), a cathode gas outlet (17), aluminum end blocks (18) tied together with tie rods (not shown), a gasket for sealing (19), an electrically insulating layer (20), graphite or meta[current collector blocks with flow fields for gas distribution (21), and gold plated current collectors (22).

Alternately, gas diffusion electrodes comprising a gas diffusion backing having a layer of an electrocatalyst coating composition thereon may be brought into contact with a solid polymer electrolyte membrane to form the MEA.

The electrocatalyst coating compositions used to apply the catalyst layers as electrodes on the CCM (10) or the GDE comprise a combination of catalysts and binders dispersed in suitable solvents for the binders, and may include other materials to improve electrical conductivity, adhesion, and durability. The catalysts may be unsupported or supported, typically on carbon, and may differ in composition depending on their use as anodes or cathodes. The binders may consist of the same polymer used to form the polymer electrolyte membrane (11), but may contain in part or be solely composed of other suitable polymer electrolytes as needed to improve the operation of the fuel cell. Some examples include Nafion®) perfluorosulfonic acid, sulfonated polyether sulfones.

The fuel cell utilizes a fuel source that may be in the gas or liquid phase, and may comprise hydrogen, an alcohol, or an ether. The fuel is humidified to the degree required to maintain adequate ionic conductivity in the solid polymer electrolyte membrane discussed above so that the fuel cell provides a high power output. Depending on the operating temperature, the fuel cell may be operated at elevated pressures to maintain the required degree of humidification. Typically a gaseous humidified hydrogen feed or methanol/water solution may be supplied to the anode compartment, and air or oxygen supplied to the cathode compartment.

Catalyst Coated Membrane:

A variety of techniques are known for CCM manufacture, which apply an electrocatalyst coating composition similar to that described above onto a solid polymer electrolyte membrane. Some known methods include spraying, painting, patch coating and screen, decal, pad or flexographic printing.

In one embodiment of the invention, the MEA (30), shown in FIG. 1, may be prepared by thermally consolidating the gas diffusion backing (GDB) with a CCM at a temperature of under about 200° C., typically about 140 to, about 160° C. The CCM may be made of any type known in the art. In this embodiment, an MEA comprises a solid polymer electrolyte (SPE) membrane with a thin catalyst-binder layer disposed thereon. The catalyst may be supported (typically on carbon) or unsupported. In one method of preparation, a catalyst film is prepared as a decal by spreading the electrocatalyst coating composition on a flat release substrate such as Kapton®) polyimide film (available from the DuPont Company). After the coating dries, the decal is transferred to the surface of the SPE membrane by the application of pressure and heat, followed by removal of the release substrate to form a catalyst coated membrane (CCM) with a catalyst layer having a controlled thickness and catalyst distribution. Alternatively, the catalyst layer is applied directly to the membrane, such as by printing, and the catalyst film is then dried at a temperature not greater than about 200° C.

The CCM, thus formed, is then combined with a GDB to form the MEA (30). The MEA is formed, by layering the CCM and the GDB, followed by consolidating the entire structure in a single step by heating to a temperature no greater than about 200° C., typically in the range of about 140 to about 160° C., and applying pressure. Both sides of the MEA can be formed in the same manner and simultaneously. Also, the composition of the catalyst layer and GDB may be different on opposite sides of the membrane.

The invention is illustrated in the following examples.

### EXAMPLES

In-Plane Conductivity Measurement

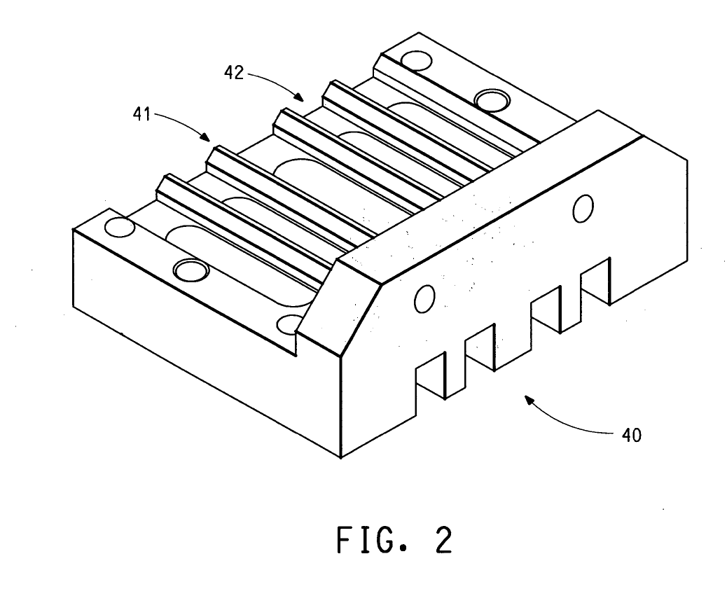

The in-plane conductivity of membranes was measured under conditions of controlled relative humidity and temperature by a technique in which the current flowed parallel to the plane of the membrane. A four-electrode technique was used similar to that described in an-article entitled “Proton Conductivity of Nafion® 117 As Measured by a Four-Electrode AC Impedance Method” by Y. Sone et al., J. Electrochem. Soc., 143, 1254 (1996) that is herein incorporated by reference. Referring to FIG. 2, a lower fixture (40) was machined from annealed glass-fiber reinforced Poly Ether Ether Ketone (PEEK) to have four parallel ridges (41) containing grooves that supported and held four 0.25 mm diameter platinum wire electrodes. The distance between the two outer electrodes was 25 mm, while the distance between the two inner electrodes was 10 mm. A strip of membrane was cut to a width between 10 and 15 mm and a length sufficient to cover and extend slightly beyond the outer electrodes, and placed on top of the platinum electrodes. An upper fixture (not shown), which had ridges corresponding in position to those of the bottom fixture, was placed on top and the two fixtures were clamped together so as to push the membrane into contact with the platinum electrodes. The fixture containing the membrane was placed inside a small pressure vessel (pressure filter housing), which was placed inside a forced-convection thermostated oven for heating. The temperature within the vessel was measured by means of a thermocouple. Water was fed from a calibrated Waters 515 HPLC pump (Waters Corporation, Milford, MA) and combined with dry air fed from a calibrated mass flow controller (200 sccm maximum) to evaporate the water within a coil of 1.6 mm diameter stainless steel tubing inside the oven. The resulting humidified air was fed into the inlet of the pressure vessel. The total pressure within the vessel (100 to 345 kPa) was adjusted by means of a pressure-control letdown valve on the outlet and measured using a capacitance manometer (Model 280E, Setra Systems, Inc., Boxborough, Ma.). The relative humidity was calculated assuming ideal gas behavior using tables of the vapor pressure of liquid water as a function of temperature, the gas composition from the two flow rates, the vessel temperature, and the total pressure. Referring to FIG. 2, the slots (42) in the lower and upper parts of the fixture allowed access of humidified air to the membrane for rapid equilibration with water vapor. Current was applied between the outer two electrodes while the resultant voltage was measured between the inner two electrodes. The real part of the AC impedance (resistance) ebetween the inner two electrodes, R, was measured at a frequency of 1 kHz using a potentiostat/frequency response analyzer (PC4/750™ with EIS software, Gamry Instruments, Warminster, Pa.). The conductivity, κ, of the membrane was then calculated as
κ=1.00 cm/(R×t×w),
where t was the thickness of the membrane and w was its width (both in cm).

### Example 1

### Irradiated Films

ETFE films were obtained in thicknesses of 30 μm and 55 μm (Tefzel® LZ5100 and LZ5200, DuPont Company, Wilmington, Del.). PVdF films were obtained with a thickness 50 μm (Kynar® Goodfellow Corp, Berwyn, Pa.). The films were degassed and brought into a nitrogen-filled glove box. They were cut to size and sealed inside gas-barrier bags (PPD aluminum-foil-barrier bags from Shield Pack, Inc., West Monroe, La.). Dry ice pellets were placed in a metal tray for cooling and the bags with films were placed into the metal tray. The films were irradiated using an electron beam accelerator using 1 MV and a current of 2.2 mA or 4.5 MV and 25 mA. Up to 6 films were placed in each bag, and the bags were stacked up to 2 high in the tray. The beam was electronically scanned across a 40″ aperture while the metal tray was moved slowly beneath the beam. Each pass resulted in a dosage of 20 kGy, and from 1 to 13 passes were used resulting in total dosages between 20 and 260 kGy. For dosages above 190 kGy, the passes were broken in to two groups with the inclusion of a three-minute pause between the groups to allow the bags to cool. The irradiated films were stored in the bags under dry ice or in a refrigerator cooled to −40° C.

### Example 2

### Emulsion Grafting

A 30 mL bottle fitted with a stirring bar was charged with 20 mL of deionized water and 4.0 mL of 20% ammonium perfluorooctanoate (C8) solution. The solution was bubbled with N₂ fbr 10:min. and 3.0 g of p-CF₂═CFC₆H₄SCF₂CF₂SO₂F were added. The resulting mixture was, ultrasonicated for 3 min to give a milky emulsion.

Four films totaling 0.380 g from Example 1 irradiated with 140 kGy dosage were weighed and placed inside 30 mL bottle with a stirring bar inside a dry box filled with nitrogen. The emulsion made above was transferred into the sealed film-containing bottle via a cannula and then the emulsion was stirred at 60° C. for 3 days. The films were removed from the bottle and washed with MeOH, acetone and water. After the grafted films were dried in a vacuum oven at 60° C. with nitrogen bleed for 2 hrs, 1.176 g of grafted films were obtained with a 209.5% graft level. Graft level was calculated as (w_{g}-w)/w, where w is the initial weight of the film and w_{g} is the weight of the dried washed grafted film.

### Example 3

### Hydrolysis of Grafted Films

Two grafted films (209% graft level) made in Example 2 were immersed in 10% KOH in H₂O:MeOH:DMSO (5:4:1 wt:wt:wt) at 60° C. for 24 hours. The films were acidified in 10% nitric acid at 60° C. for 60 hrs, then rinsed with deionized water to neutral pH. The hydrolyzed film was swollen to 58 μm thickness. The conductivity of the sample was measured in-plane at 80° C. under controlled humidity, varying from 25% first to 95% at the end. The conductivity values are given in the Table 2 below

TABLE 2

| Temperature ⁽° C.) | RH (%) | Conductivity (mS/cm) |
|---|---|---|
| 80 | 25 | 12 |
| 80 | 50 | 52.7 |
| 80 | 95 | 231.7 |

### Example 4

### Emulsion Grafting

A 30 mL, bottle fitted with a stirring bar was charged with 20 mL of deionized water and 4.0 mL of 20% ammonium perfluorooctanoate (C8) solution. The solution was bubbled with N₂ for 10 min. 3.0 g of p-CF₂═CFC₆H₄SCF₂CF₂SO₂F and 0.3 g of 1,4-di(trifluorovonyl)benzene were added. The resulting mixture was ultrasonicated for 3 min to give a milky emulsion.

Four films from Example 1-,each weighing 0.266 g, irradiated with 140 kGy dosage were weighed and placed inside a 30 mL bottle with a stirring bar and placed inside a dry box filled with nitrogen. The emulsion made above was transferred into the sealed film-containing bottle via a cannula and then the emulsion was stirred at 55° C. for 3 days. The films were removed from the bottle and washed with MeOH, acetone and water. After the grafted films were dried in a vacuum oven at 60° C. with nitrogen bleed for 2 hours, 0.366 g of grafted films were obtained. A 37.6% graft level was calculated using the formula: (w_{g}-w)/w, where w is the initial weight of the film and w_{g} is the weight of the dried grafted film

### Example 5

### Oxidation of Grafted Membrane

A membrane made in example 4 was immersed in 3.0 g of CrO₃ in 50 mL CH₃CO₂H at 60° C. for 24 hrs. The film was removed and washed with water and then immersed in 100 mL of 10% HNO₃ at 60° C. for 24 hrs.

The clear film was washed with water and immersed in 15% HNO₃ again at 60° C. for 24 hrs. The film was washed with water to neutral pH. The hydrolyzed film was swollen to 38 μm thickness. The conductivity of the sample was measured in-plane at 80° C. under controlled humidity, varying from 25% first to 95% at the end. The conductivity values are given in the Table 4 below.

TABLE 4

| Temperature (° C.) | RH (%) | Conductivity (mS/cm) |
|---|---|---|
| 80 | 25 | 13.2 |
| 80 | 50 | 53.1 |
| 80 | 95 | 347.7 |

A kinetic TGA study using ASTM E1641-99 modified to use wet air and heating rates of 1, 3, 5, and 10 deg/min, indicated that the calculated time for completion of 10% of the first stage of decomposition at 120° C. was 1.4×108 hours.

### Example 6

### Emulsion Grafting

A 0.5 L two or three necked clean flask fitted with condenser topped with a N₂ inlet/outlet, and a stirring bar was charged with 100 mL of deionized water and 8.4 mL of 20% ammonium perfluoroodanoate (C8) solution. The solution was bubbled with N2 for 30 min. 15 g (42.4 mmol) of p-CF₂═CFC₆H₄OCF₂CF₂SO₂F was added. The resulting mixture was ultrasonicated for 5 min to give milky emulsion.

Irradiated films from Example 1, with 20 kGy dosage, were weighed and placed inside a glass jar inside a dry box filled with nitrogen. The emulsion made above was transferred into the glass jar under nitrogen and a Teflong® mesh was used to hold the films under the emulsion. The jar was covered under N₂ and heated with stirring at 70° C. The films were removed from the jar after time specified in the Table below and washed with MeOH, acetone and water. The grafted films were dried in a vacuum oven at 70° C. with nitrogen bleed overnight and then were heated in THF at 70° C. for 4 hours to further remove residual monomer and/or polymer which was not bonded to the base film. The films were dried in a vacuum oven at 70° C. with nitrogen bleed, re-weighed, and the uptake calculated. Uptake was calculated as (w_{g}-w)/w, where w is the initial weight of the film and w_{g} is the weight of the dried grafted film after the THF extraction.

| | | Init. | Final | Wt |
|---|---|---|---|---|
| | Time | Weight | Weight | uptake |
| Film | (h) | (g) | (g) | (%) |
| PVdF (1 mil) | 24 | 0.106 | 0.215 | 102.8 |
| PVdF (1 mil) | 48 | 0.111 | 0.225 | 102.7 |
| PVdF (1 mil) | 72 | 0.103 | 0.213 | 106.8 |
| ETFE (2 mil) | 24 | 0.200 | 0.393 | 96.5 |
| ETFE (2 mil) | 48 | 0.225 | 0.454 | 101.8 |
| ETFE (2 mil) | 72 | 0.216 | 0.450 | 108.3 |

### Example 7

### Emulsion Grafting

A 0.5 L two or three necked clean flask fitted with condenser topped with a N₂ inlet/outlet, and a stirring bar was charged with 100 mL of deionized water and 8.4 mL of 20% C8 solution. The solution was bubbled with N₂ for 30 min.15 g (42.4 mmol):of p-CF₂═CFC₆H₄OCF₂CF₂SO₂F were added. The resulting mixture was,; ultrasonicated for 5 min to give a milky emulsion.

Irradiated films from Example 1 with 40 kGy dosage were weighed and placed inside a glass jar inside a dry box filled with nitrogen. The emulsion made above was transferred into the glass jar under nitrogen and a Teflon® mesh was used to hold the films under the emulsion. The jar was covered under N₂ and heated with stirring at 70° C. The films were removed from the jar after certain time and washed with MeOH, acetone and water. The grafted films were dried in a vacuum oven at 70° C. with nitrogen bleed over night and then were heated in THF at 70° C. for 4 hours to further remove residual monomer and/or polymer that was not bonded to the base film. The films were dried in a vacuum oven at 70° C. with nitrogen bleed, re-weighed, and the uptake calculated. Uptake was calculated as (w_{g}-w)/w, where w is the initial weight of the film and w_{g} is the weight of the dried grafted film after the THF extraction.

| | | Init. | Final | Wt |
|---|---|---|---|---|
| | Time | Weight | Weight | uptake |
| Film | (h) | (g) | (g) | (%) |
| ETFE (2 mil) | 24 | 0.237 | 0.279 | 23.2 |
| ETFE (2 mil) | 48 | 0.211 | 0.311 | 50.2 |

### Example 8

### Emulsion Grafting

A 0.5 L, two or three necked, clean flask fitted with condenser topped with a N₂ inlet/outlet, and a stirring bar was charged with 100 mL of deionized water and 8.4 mL of 20% C8 solution. The solution was bubbled with N₂ for 30 min. 15 g (42.4 mmol) of p-CF₂═CFC₆H₄OCF₂CF₂SO₂F were added. The resulting mixture was ultrasonicated for 5 min to give a milky emulsion.

Irradiated films from Example 1 with 140 kGy dosage were weighed; and placed inside a glass jar inside a dry box filled with nitrogen. The emulsion made above was transferred into the glass jar under nitrogen and a Teflon® mesh was used to hold the films under the emulsion. The jar was covered under N₂ and heated with stirring at 70° C. The films were removed from the jar after certain time and washed with MeOH, acetone and water. The grafted films were dried in a vacuum oven at 70° C. with nitrogen bleed overnight and then were heated in THF at 70° C. for 4 hours to further remove residual monomer and/or polymer which was not bonded to the base film. The films were dried in a vacuum oven at 70° C. with nitrogen bleed, reweighed, and the uptake calculated. Uptake was calculated as (w_{g}-w)/w, where w is the initial weight of the film and w_{g} is the weight of the dried grafted film after the THF extraction.

| | | Init. | Final | Wt |
|---|---|---|---|---|
| | Time | Weight | Weight | uptake |
| Film | (h) | (g) | (g) | (%) |
| ETFE (1 mil) | 8 | 0.097 | 0.234 | 141.2 |
| ETFE (1 mil) | 24 | 0.116 | 0.477 | 311.2 |
| ETFE (1 mil) | 48 | 0.106 | 0.539 | 408.5 |
| ETFE (1 mil) | 72 | 0.102 | 0.520 | 409.8 |
| ETFE (1 mil) | 72 | 0.465 | 0.2.333 | 401.7 |

### Example 9

### Hydrolysis and Conductivity

A grafted 1 mil ETFE film having 141% weight gain was immersed in 10 wt % KOH in H₂O: MeOH: DMSO 5:4:1 wt:wt:wt in a Petri dish@50 ° C. overnight two days. The film was rinsed in deionized water for 5 minutes at ambient temperature. The film was ion-exchanged to acid form by dipping in 14% nitric acid at 50° C. for 2 hr twice, followed by rinsing in deionized water and then three successive soaks in deionized water for 15 minutes at room temperature and then boiled in water for 1 hr. The hydrolyzed sample was swollen to 36 μm. thickness. The conductivity of the sample was measure in-plane at 120 GC under controlled humidity varying from 25% first to 95% at the end. The conductivity values are given in the table below:

| RH % | Conductivity (mS/cm) |
|---|---|
| 25 | 17.7 |
| 50 | 69.8 |
| 95 | 368.3 |

### Example 10

A 250-ml 3-neck round bottom flask was equipped for purging with nitrogen using needles through rubber septa and also with a magnetically-driven stir bar. To the flask was added 70 ml water and 12 ml of an aqueous solution containing 20 wt % of C8. The solution was deoxygenated for 10 min by bubbling with nitrogen. The monomer p-CF₂═CF—S(CF₂)₂SO₂F, 6 g, was added using a syringe and the mixture deoxygenated for an additional 5 min with nitrogen. The mixture was sonicated for 5 min using a probe tip introduced through a septum driven by a 200 W 40 kHz supply (Dukane 40P200T). The flask containing the emulsion was partially evacuated and refilled with nitrogen three times and brought into a nitrogen-purged glove box. Two Tefzel® films from Example 1, dimensions 27 μm×100 mm×110 mm and irradiated to 140 kGy, were brought into the glove box and weighed. One film was placed into each of two Nylon boxes of interior dimensions 6.4 mm×170 mm×170 mm. To each box was added one half of the emulsion, approximately 43 ml. The second box (B) had an additive consisting of 0.3 g of α,α,α-trifluorotoluene (TFT) added to the emulsion. The boxes were sealed closed with Nylon covers and rubber gaskets around the edges The boxes were placed in a larger box heated to 60° C. and gently shaken at 125 rpm for 96 hr. After this grafting reaction, the films were removed from the Nylon boxes, rinsed with water, dried in ambient air, reweighed, and their size remeasured. The weight uptake and dimensions are indicated in the table below. The film B with the additive had a higher rate of grafting and was smoother than film A without the additive.

| Sample | TFT | Wt. uptake | Post-graft dimensions |
|---|---|---|---|
| A | 0.0 g | 250% | 44 μm × 125 mm × 145 mm |
| B | 0.3 g | 370% | 49 μm × 160 mm × 175 mm |

### Example 11

A bottle was charged with 80 mL of deionized water and 12 mL of 20% Zonyl® FS-62 solution. The mixture was bubbled with N₂ for 10 min., and 4.0 g of p-CF₂═CFC₆H₄SCF₂CF₂SO₂F were added. The resulting mixture was ultrasonicated for 3 min to give a milky emulsion, which was transferred into a reactor containing Tefezl® films (0.287 g and 0.313 g, respectively) irradiated with 200 kGy dosage under nitrogen. The sealed reactor was shaken at 60° C. for 3 days. The films were removed from the bottle and washed with MeOH, acetone and water. After the grafted films were dried in a vacuum oven at 60° C. with nitrogen bleed for 2 hrs to give 0.898 g (210% graft level) and 0.983 g (214% graft level) of films, respectively. Graft level was calculated as (w_{g}-w)/w, where w is the initial weight of the film and w_{g} is the weight of the dried washed grafted film.

What is claimed is:

1. A grafting process for making a fluorinated ion exchange polymer membrane comprising:
(a) forming an monomer composition comprising at least one grafting monomer, in emulsion form, in the presence of a fluorinated surfactant;
wherein the grafting monomer comprises one or more of 1a, 1b, 2, or 2b: 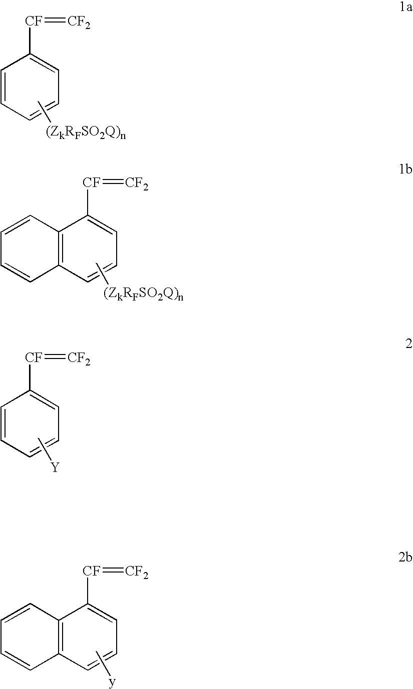
wherein Zₖ comprises S, SO₂, or POR wherein R comprises a linear or branched perfluoroalkyl group of 1 to 14 carbon atoms optionally containing oxygen or chlorine, an alkyl group of 1 to 8 carbon atoms, an aryl group of 6 to 12 carbon atoms or a substituted aryl group of 6 to 12 carbon atoms;
R_{F} comprises a linear or branched perfluoroalkylene group of 1 to 20 carbon atoms, optionally containing oxygen or chlorine;
Q is chosen from F, —OM, —NH₂, —N(M)SO₂R²_{F}, and —C(M)(SO₂R²^{F})₂, wherein M comprises H, an alkali cation, or ammonium;
R²_{F} comprises an alkyl group of 1 to 14 carbon atoms which may optionally include ether oxygens or aryl of 6 to 12 carbon atoms where the alkyl or aryl groups may be perfluorinated or partially fluorinated,
Y comprises H; halogen such as Cl, Br, F or I; linear or branched alkyl or perfluoroalkyl groups, wherein the alkyl group comprises C1 to C10 carbon atoms; or a perfluoroalkyl group containing oxygen, chlorine or bromine, and wherein the alkyl group comprises C1 to C10 carbon atoms, —CF═CF₂, —(R_{F}SO₂F)n, —(SO₂Q)ₙ, —(PO₃M₂)ₙ, —(CO₂M)ₙ;
n is 1 or 2 for 1 and 2, and n is 1, 2, or 3 for 1b and 2b; and k is 0 or 1;
(b) irradiating at least one base polymer with ionizing radiation, and
(c) contacting at least one base polymer with the monomer composition from step (a), at a temperature of about 0° C. to about 120° C. for about 0.1 hours to about 500 hours.

2. The process of claim 1 wherein the surfactant is ammonium perfluorooctanoate, Zonyl® fluorinated surfactants, or a fluorinated alkyl ammonium salt.

3. The process of claim 2 wherein the surfactant is ammonium perfluorooctanoate, Zonyl® 62, Zonyl® TBS, Zonyl® FSP, Zonyl® FS-62, Zonyl® FSA, Zonyl® FSH or R′_{w}NH(_{4-w})X, wherein X is Cl⁻, Br⁻, I⁻, F⁻, HSO₄⁻, or H₂PO₄⁻ and wherein R′ is (R_{F}CH₂CH₂)—.

4. The process of claim 1 wherein the surfactant optionally includes an enhancing additive.

5. The process of claim 4 wherein the enhancing additive is α,α,α-trifluorotoluene, dichlorobenzotrifluoride, chlorobenzotrifluoride, chlorobenzene, dichlorobenzene, trichlorobenzene, fluorobenzene, difluorobenzene, trifluorobenzene, perfluorobenzene, toluene, p-xylene, m-xylene, o-xylene, or a C5-C10 aliphatic hydrocarbon, fluorohydrocarbon, fluorocarbon, or fluoroether.

6. The process of claim 1 wherein the surfactant is present at an amount of 0.001 to 15 weight percent of the emulsion.

7. The process of claim 6 wherein the surfactant is present at an amount of 0.01 to 5 weight percent of the emulsion.

8. The process of claim 4 wherein the enhancing additive is present at an amount of 0.5 to 300 weight % of the monomer.

9. The process of claim 1 wherein Y is —(R_{F}SO₂F)ₙ.

10. The process of claim 1 wherein the at least one base polymer is in film form.

11. The process of claim 1 wherein steps (b) and (c) are performed simultaneously.

12. The process of claim 1 wherein steps (b) and (c) are performed sequentially.

13. The process of claim 1 wherein Q is F.

14. The process of claim 1 wherein R_{F} is chosen from (CF₂)_{q} wherein q=1 to 16, (CF₂)_{q}OCF₂CF₂ wherein q=1 to 12, and (CF₂CF(CF3)O)_{q}CF₂CF₂ where q is 1 to 6, and R²_{F} is chosen from methyl, ethyl, propyl, butyl, and phenyl, each of which may be partially fluorinated or perfluorinated.

15. The process of claim 14 wherein R_{F} is chosen from (CF₂)_{q} wherein q=1 to 4, (CF₂)_{q}OCF₂CF₂ wherein q=1 to 4, and (CF₂CF(CF3)O)_{q}CF₂CF₂ where q is 1 to 2, and R²_{F} is chosen from perfluoromethyl, perfluoroethyl, and perfluorophenyl.

16. The process of claim 1 wherein the base polymer comprises a homopolymer or copolymer prepared from non-fluorinated, fluorinated, or perfluorinated monomers.

17. The process of claim 16 wherein the base polymer is chosen from poly(ethylene-tetrafluoroethylene), poly(ethylene-chlorotrifluoroethylene), poly(tetrafluoroethylene-hexafluoropropylene), poly(tetrafluoroethylene-perfluoroalkyl vinyl ether), poly(tetrafluoroethylene-perfluoromethyl vinyl ether), poly(tetrafluoroethylene-perfluoropropyl vinyl ether), polytetrafluoroethylene, modified polytetrafluoroethylene, polyvinyl fluoride, polyvinylidene fluoride, poly(vinylidene fluoride-hexafluoropropylene), polyethylene, and polypropylene.

18. The process of claim 16 wherein the base polymer comprises a partially or completely fluorinated polymer.

19. The process of claim 18 wherein the base polymer is chosen from poly(ethylene-tetrafluoroethylene), poly(ethylene-tetrafluoroethylene-termonomer), poly(tetrafluoroethylene-hexafluoropropylene), poly(tetrafluoroethylene-perfluorovinylether), polytetrafluoroethylene, poly(ethylene-chlorotrifluoroethylene); poly(vinylidene fluoride), and poly(vinylidenefluoride-hexafluoropropylene).

20. A polymer made by the process of claim 1.

21. A catalyst coated membrane comprising a polymer electrolyte membrane having a first surface and a second surface, wherein the polymer electrolyte membrane comprises the polymer of claim 20.

22. A membrane electrode assembly comprising a polymer electrolyte membrane, having a first surface and a second surface, wherein the polymer electrolyte membrane comprises the polymer of, claim 20.

23. An electrochemical cell comprising a membrane electrode assembly, wherein the membrane electrode assembly comprises a polymer electrolyte membrane, having a first surface and a second surface, wherein the polymer electrolyte membrane comprises the polymer of claim 20.

24. The electrochemical cell of claim 23 wherein the electrochemical cell is a fuel cell.
